(19) United States
(12) Patent Application Publication
(10) Pub. No.: US 2024/0383040 A1
(43) Pub. Date: Nov. 21, 2024

(54) MULTIMODULAR RING MODE FIBER OPTIC CONFIGURATION, FINE PROCESS CONTROL STRATEGY FOR PRINTER OPTICS, AND LASER POWDER BED FUSION POWER CONSUMPTION OPTIMIZATION BY FEEDSTOCK MANIPULATION

(71) Applicant: Divergent Technologies, Inc., Los Angeles, CA (US)

(72) Inventors: Seyedalireza TORBATISARRAF, Los Angeles, CA (US); Michael Thomas Kenworthy, Rancho Palos Verdes, CA (US); Chan Cheong Pun, Costa Mesa, CA (US)

(21) Appl. No.: 18/669,455

(22) Filed: May 20, 2024

Related U.S. Application Data
(60) Provisional application No. 63/503,435, filed on May 19, 2023.
(60) Provisional application No. 63/509,502, filed on Jun. 21, 2023.
(60) Provisional application No. 63/510,077, filed on Jun. 23, 2023.

(51) Int. Cl. B22F 10/28; B33Y 10/00; B33Y 30/00; B33Y 50/02

(52) U.S. Cl. CPC B22F 10/28; B33Y 10/00; B33Y 30/00; B33Y 50/02

(57) ABSTRACT

Systems and methods for multi modular ring mode fiber optic configuration, laser powder bed fusion, and fine process control during an additive manufacturing (AM) process. A multi-mode ring laser beam with a first power distributed in a first beam is generated, as a spot beam or a first ring beam, and a second power distributed in a second ring beam surrounding the first beam. The multi-mode ring laser beam is applied to one or more materials to transform the material(s) into an AM build piece. An AM method includes depositing a powder first material in a powder bed, exposing the powder first material to a second material, wherein an absorption coefficient of the second material is higher than an absorption coefficient of the first material at the wavelength, and applying a laser beam with a wavelength to the powder first material and the second material to generate a composite material. An AM method includes controlling an optical component to apply a laser beam to a region of material during an AM process, receiving sensor data regarding the region; determining a process characteristic of the region based on the sensor data, obtaining a comparison by comparing the process characteristic to a target characteristic, and modifying a variable corresponding to control of the optical component based on the comparison that modifies a printing output in accordance with a target output.

### CROSS-REFERENCE TO RELATED APPLICATIONS

The present disclosure claims the benefit under 35 U.S.C. 119 of U.S. Provisional Patent Application No. 63/503,435, filed May 19, 2023, and titled “MULTIMODULAR RING MODE FIBER OPTIC CONFIGURATION”; U.S. Provisional Patent Application No. 63/509,502, filed Jun. 21, 2023, and titled “FINE PROCESS CONTROL STRATEGY FOR PRINTER OPTICS”; and U.S. Provisional Patent Application No. 63/510,077, filed Jun. 23, 2023, and titled “LASER POWDER BED FUSION POWER CONSUMPTION OPTIMIZATION BY FEEDSTOCK MANIPULATION,” which applications are incorporated by reference herein in their entirety.

### BACKGROUND

### Field

The present disclosure relates generally to additively manufactured structures, and more specifically to selectively modifying characteristics at interface locations of additively manufactured structures.

### Description of the Related Technology

Some Additive Manufacturing (AM) processes involve the use of a stored geometrical model for accumulating materials layer by layer on a “build plate” to produce three-dimensional (3-D) objects having features defined by the model. AM techniques are capable of printing complex parts or components using a wide variety of materials. A 3-D printed object is fabricated based on and using a computer-aided design (CAD) model. The AM process can manufacture a solid 3-D object directly from the CAD model using an AM printer without using additional tooling.

One example of an AM process or technique is powder bed fusion (PBF). PBF uses a laser, electron beam, or other energy source to sinter or melt powder that has been deposited in a powder bed. This sintering or melting consolidates powder particles together in targeted areas and, layer by layer, produces a 3-D structure having the desired geometry. Different materials or combinations of materials, such as metals, plastics, and ceramics, may be used in PBF to create the 3-D object. Other AM processes and techniques, including those discussed further below, are also available or under current development, and parts or all of the present disclosure may be applicable to each of these various processes and techniques.

Major roadblocks in advanced AM system development include burdensome processes for optical calibration and evolving needs for in process correction for modern processing parameters with high AM rates and high power systems. Generally, Individual scanners may be calibrated within a specific tolerance for key performance factors such as beam quality, spot size, delivered vs commanded power, etc. These individual scanners are then aligned (e.g., via scanfield alignment) within a target tolerance capability (e.g., 50-100 micrometers), which is roughly on the order of the individual scanner capability for positioning across the working volume. Under operating conditions, the process will shift due to thermal effects on the various optical components and is coupled with the geometric variation in the design being printed.

One of the challenges of printing material through Laser Powder Bed Fusion is the low absorption rate of non-ferrous and Ni alloys within the range of red lasers. This challenge necessitate increasing a Laser Power YoY in order to increase the productivity of AM printing. However, this also introduces challenges due to high power consumption with low efficiency, and excessive heat introduced in an AM print chamber, which requires effective management. Thermal lensing effects on an optical train and associated thermal shifts at high power are two such factors requiring effective management. Alternatively, the usage of Green lasers improved the absorptivity of highly conductive materials such as copper and Au. However, materials such as Aluminum still have not fully benefited from the concept.

One or more aspects of the present disclosure may be described in the context of the related technology. None of the aspects described herein are to be construed as an admission of prior art, unless explicitly stated herein.

### SUMMARY

Several aspects of additively manufactured structures, and more specifically to selectively modifying characteristics at interface locations of additively manufactured structures, are described herein.

In some aspects, a process correction of thermal drift and/or thermal lensing effects is included that achieves a desired output quality. While low quality is exhibited visually as poorly aligned scan fields, which appear as stair steps or shifts in the target geometry across the surface, and obviously also extend into the internal material quality which may exhibit a lack of fusion resulting in defects or overheated regions within an AM part. Nominal beam spot for a standard Gaussian energy distribution is on order of 80-90 micrometers, which is greater than a 10% variation. However, for an industrial AM system with eight or more optics processing simultaneously, optic-to-optic variation is accepted in the current technology state and material design data is therefore generate based on this inherent wide variability. This variability in energy distribution also restricts AM processing of certain materials that require a much tighter level of process control due to a small processing window of success.

In various aspects, this disclosure proposes a novel methodology to deliver equivalent and more consistent optical behavior throughout an AM build. A closed loop control of the beam spot size and energy distribution is implemented by dynamically controlling magnification during delivery of an AM beam. Through sensed optical emissions from the material being welded, certain inferences can be made, including thermal conditions of the AM material being processed as well as other melt pool characteristics such as the size and shape which strongly correlate to the beam output characteristics measured during calibration of the system. By evaluating these specific build characteristics against an expected reference set of characteristics (i.e., a benchmark), the aspects described herein can be implemented to determine how to modify beam energy delivery to meet target processing parameters. Applying the techniques herein and using this data for an exemplary Gaussian energy beam, can provide for dynamic adjustment of a beam output to a target inferred spot size based on measured melt pool characteristics during the AM process. This occurs, for example, during a recoating time between AM of subsequent layers. It is also feasible to perform intra-layer adjustment as well, with sufficiently fast processing capabilities and algorithms. For example, instead of accepting the baseline 80-90 micrometer tolerance band described in the above example for a notional Gaussian energy beam, the effective size of the beam can be controlled within 1 or 2 micron, not only under calibration conditions, which are effectively static and not representative of the real high-energy processing, but also during an AM build of a part with layer-to-layer geometry variation. In simple terms, this is achieved by exerting a fine level of control of the dynamic magnification or zoom to alter the energy beam size at a much higher level of granularity than typical systems in use today, which operate primarily at a fixed magnification of about 1.5 or 2.0. In this case, the nominal magnification or “zoom” target for the process may be 1.5, but the actual individual optics will be at various zooms between 1.450 to 1.550, in order to achieve nearly identical output characteristics within a desired tolerance level (which can be affected by materials). This results in a more stable process with repeatable outcomes for a variety of geometries being processed.

### BRIEF DESCRIPTION OF THE DRAWINGS

Various aspects of alloys, ceramics, polymers, and other materials that may be used for additive manufacturing, for example, in automotive, aerospace, and/or other engineering contexts are presented in the detailed description by way of example, and not by way of limitation, in the accompanying drawings, wherein:

FIG. 1A illustrates a PBF system after a slice of build piece has been fused, but before the next layer of powder has been deposited.

FIG. 1A, this figure shows PBF system after a slice of build piece has been fused, but before the next layer of powder has been deposited.

FIG. 1C shows PBF system at a stage in which depositor is positioned to deposit powder in a space created over the top surfaces of build piece and powder bed and bounded by powder bed receptacle walls.

FIG. 1D shows PBF system at a stage in which, following the deposition of powder layer.

FIG. 1E illustrates a functional block diagram of a 3-D printer system in accordance with an aspect of the present disclosure.

FIG. 2A illustrates a cross-sectional view of a multi modular ring mode fiber optic configuration in accordance with aspects of the present disclosure.

FIG. 2B illustrates a cross-sectional view of a multi modular ring mode fiber optic configuration for a ring in accordance with aspects of the present disclosure.

FIG. 3 illustrates a flowchart of a method for multi modular ring mode fiber optic configuration in accordance with various aspects of the present disclosure.

FIG. 4 illustrates a flowchart of a method for fine process control strategy for printer optics in accordance with various aspects of the present disclosure.

FIG. 5A shows an illustration graph of a laser absorption coefficient versus wavelength, including application of a green laser and a fundamental wave.

FIG. 5B shows an illustration graph of a laser absorption coefficient versus wavelength, including application of a green laser and a fundamental wave.

FIG. 5C shows an illustration graph of a laser absorption coefficient versus wavelength, including application of a blue laser and an infrared laser range, for various materials.

FIG. 6 shows an illustration of a material, including a base material and outer layer.

FIG. 7 shows flowchart of an example method according to various embodiments.

### DETAILED DESCRIPTION

The detailed description set forth below in connection with the appended drawings is intended to provide a description of various exemplary aspects are not intended to represent the only aspects in which the disclosure may be practiced. The term “exemplary” used throughout this disclosure means “serving as an example, instance, or illustration,” and should not necessarily be construed as preferred or advantageous over other aspects presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

In various aspects, a recoater can include one or more specialized loader, allowing for one or more different materials to be dosed in accordance with desired spatial locations on a print bed. In some aspects a material selector can be included. The material selector can be used in accordance with or otherwise provide sufficient resolution to precisely match a desired powder with desired coordinates (e.g., x-, y- and/or z-coordinates) so as to accurately position powder particles within or at locations in a given layer during an AM process.

Regarding the powder(s), in various aspects a desirable powder(s) may exhibit one or more particular characteristics that benefit, improve, and/or otherwise effect the AM process in a desirable way. For example, desirable powder(s) can have characteristics such as generally having particles of sufficient density and/or size differences or uniformity so as to be effectively discriminated from other particles by various commonly employed methods. Such methods of discrimination include air classification, which can discriminate according to particle mass, or sieving, which can primarily discriminate based on a size and/or shape of particles. As an example, a powder may include a combination of copper and aluminum. In such powder, a large particle size distribution (PSD) may exist between the copper particles (e.g., from about 80-120 microns) and a smaller PSD may exist between the aluminum particles (e.g., from about 35-75 microns). In this example powder, the largest and heaviest aluminum particle would be about one-third of the mass of the smallest copper particle. Because this particle size difference is discrete, the copper and aluminum particles should be separable, which can be economically advantageous or beneficial through the use of recycling.

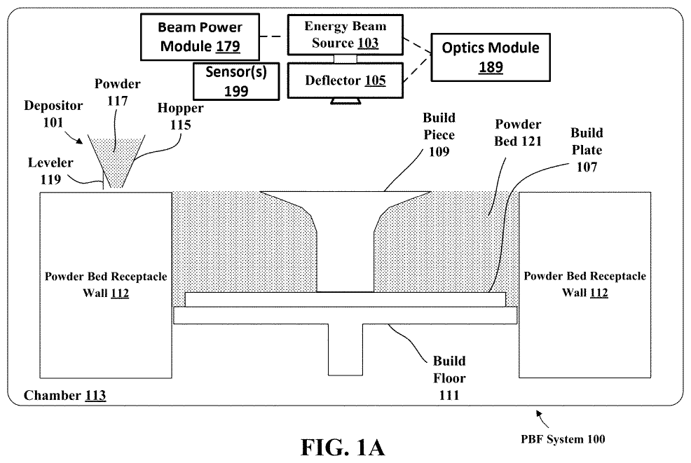

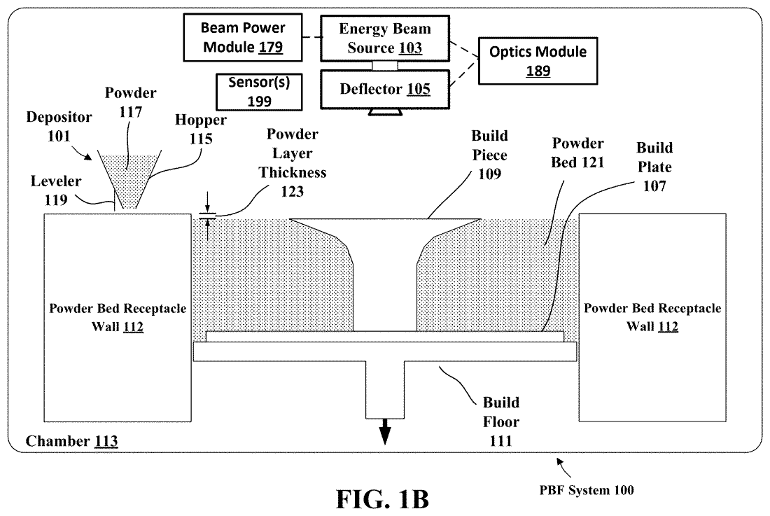

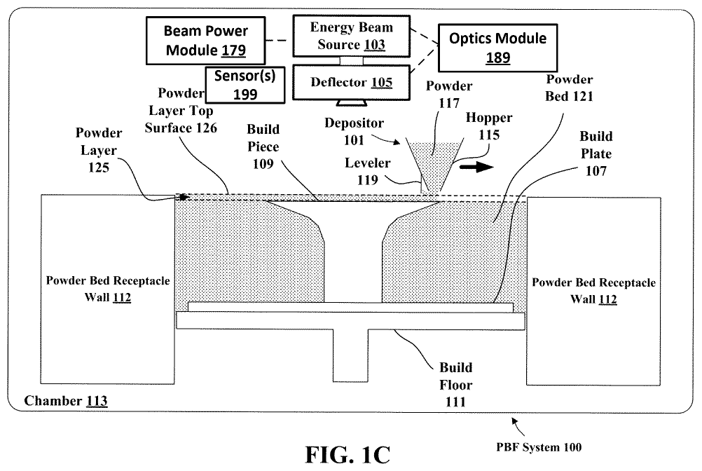

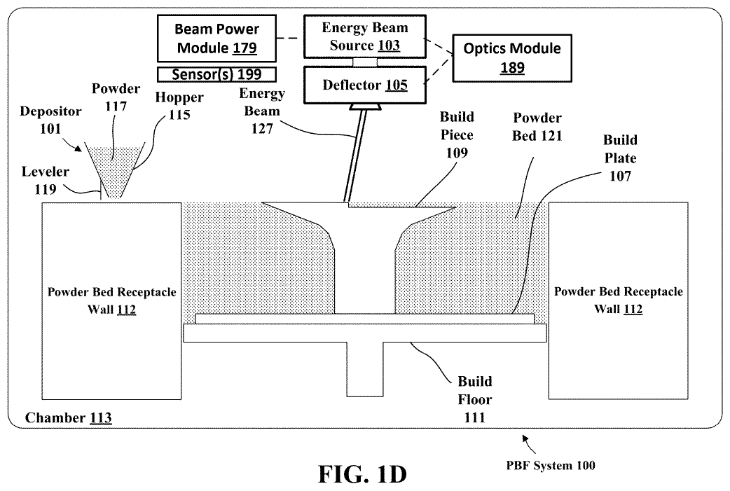

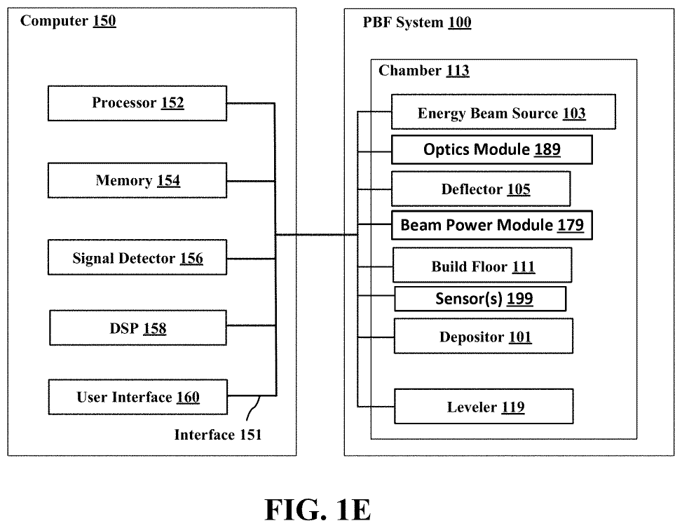

FIGS. 1A-D illustrate respective side views of an exemplary 3-D printer system for a selective laser sintering build operation.

In this example, the 3-D printer system is a powder-bed fusion (PBF) system 100. FIGS. 1A-D show PBF system 100 during different stages of operation. The particular aspects illustrated in FIGS. 1A-D is one of many suitable examples of a PBF system employing principles providing some of the basis of this disclosure. It should also be noted that elements of FIGS. 1A-D and the other figures in this disclosure are not necessarily drawn to scale but may be drawn larger or smaller for the purpose of better illustration of concepts described herein.

PBF System 100 may be an electron-beam PBF system 100, a laser PBF system 100, or other type of PBF system 100. Further, other types of 3-D printing, such as Directed Energy Deposition, Selective Laser Melting, Binder Jet, etc., may be employed without departing from the scope of the present disclosure.

PBF system 100 can include a depositor 101 that can deposit each layer of powder from one or more powders 117, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of and/or associated with various aspects of the present disclosure. In various embodiments, energy beam source 103 can include a multi-mode ring laser configured to generate multiple beams, e.g., a first beam (which may be a spot beam or a first ring beam) and a second ring beam surrounding the first beam. In various embodiments, the multi-mode ring laser may further be configured to generate beams of varying power (such as with a beam power module 179, described in more detail below) and/or adjust the beams with various optics to, e.g., magnify, zoom, etc. (such as with an optics module 189, described in more detail below). Although shown as individual components in FIGS. 1A-E, energy beam source 103, beam power module 179, and/or optics module 189 may be variously incorporated into a single component or two components as one skilled in the art would readily understand.

PBF system 100 can also include a build floor 111 positioned within a powder bed receptacle. The walls 112 of the powder bed receptacle generally define the boundaries of the powder bed receptacle, which is located between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation mitigating contamination risks, and allowing for unused powder to be recycled. Depositor 101 can include one or more hopper 115. The one or more hopper 115 can contain the one or more powder 117, such as a metal powder, alloy, or other material. Depositor 101 can also include at least one leveler 119 that can level the top of each layer of deposited powder. Leveler 119 can be located in different locations in different aspects.

AM processes may produce the build object and may also produce various support structures that maintain structural integrity of the build object during AM processes. Support structures can be nonessential to the build object upon build object completion and may require removal to reduce weight, improve energy distribution, improve aesthetics, or for other beneficial reasons. The particular aspects illustrated in FIGS. 1A-D are some suitable examples of a PBF system with one or more hopper employing principles of the present disclosure. Specifically, support structures and interfaces between support structures and build objects that have characteristics that vary from characteristics of the build objects themselves described herein may be used in at least one PBF system 100 described in FIGS. 1A-D. Methods of selectively manufacturing various aspects according to desired outcomes are also disclosed herein. While one or more methods described in the present disclosure may be suitable for various AM processes (e.g., using a PBF system, as shown in FIGS. 1A-D), it will be appreciated that one or more methods of the present disclosure may be suitable for other applications, as well. For example, one or more methods described herein may be used in other fields or areas of manufacture without departing from the scope of the present disclosure. Accordingly, AM processes employing the one or more methods of the present disclosure are to be regarded as illustrative and are not intended to limit the scope of the present disclosure.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

In various aspects such powder in powder bed 121 can be beneficially harvested, recaptured, and/or recycled for use in the same or other projects. This can reduce waste, cut costs, and provide other benefits. Systems and methods of such harvesting, recapture, and/or recycling are described herein in further detail, although others are possible based on the characteristics of the materials.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B) and exposing powder layer top surface 126. Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously deposited layers discussed herein with reference to FIG. 1A.

FIG. 1D shows PBF system 100 at a stage in which, following the deposition of powder layer 125 (FIG. 1C), energy beam source 103 generates one or more energy beam 127 and deflector 105 applies the energy beam to fuse the next slice in build piece 109. In various aspects, energy beam source 103 can be a laser, in which case energy beam 127 is a laser beam. Deflector 105 can include an optical system that uses reflection and/or refraction to manipulate the laser beam to scan selected areas to be fused. Although a single energy beam 127 is shown in FIGS. 1A-1D for simplicity and clarity, it should be understood from the present disclosure that one or more energy beams can and are selectively generated according to various aspects herein. Further description of such multi-beam configurations is proved in the present disclosure.

As shown in FIGS. 1A-1E, in various aspects, an optics module 189 can be communicatively coupled with energy beam source 103 and/or deflector 105. Optics module can include additional components that are configured to perform various actions and selectively generate various features. For example, magnification through optical means can be performed on energy beam 127 at energy beam source 103, deflector 105, or elsewhere, whereby a spot size of energy beam 127 is selectively manipulated to generate desired effects, such as increasing or decreasing the spot size. In such instances, optics module 189 can include, be integrated with, be coupled with, and/or control one or more optical components, such as one or more lenses, positioners, motors, gimbals, actuators, prisms, polarizers, filters, attenuators, reticles, and/or other components of optical systems as appropriate to generate a desired magnification or reduction of spot size. Optics module 189 can include one or more communications interface, memory, processor, and/or other components, as appropriate and/or required.

Also shown in FIGS. 1A-1E is a beam power module 179. In various aspects, ring mode lasers can be employed to introduce shaping of the energy beam 127 (i.e., beam-shaping), which can selectively generate desired effects at an application point where the energy beam spot is being applied to powder. Beam power module 179 can include one or more components configured to selectively modify and/or tune power delivery to and/or in energy beam source. In some aspects, beam power module 179 can be integrated with energy beam source 103, while in some aspects beam power module 179 can be self-contained or distributed elsewhere and communicatively coupled with energy beam source 103. Functionality of beam power module 179 is discussed in further detail herein. Beam power module 179 can include one or more communications interface, memory, processor, and/or other components, as appropriate and/or required.

Also shown in FIGS. 1A-1E is one or more sensor(s) 199. In various aspects, sensor(s) 199 can be employed to sense a region of material during an AM process. In various embodiments, sensor(s) 199 may include, e.g., one or more of a photodiode, an optical tomography (OT) camera, or an eddy current sensor.

In various aspects, the deflector 105 can include one or more gimbals and actuators that can rotate and/or translate the energy beam source to position the energy beam. In various aspects, energy beam source 103 and/or deflector 105 can modulate the energy beam, e.g., turn the energy beam on and off as the deflector scans so that the energy beam is applied only in the appropriate areas of the powder layer. For example, in various aspects, the energy beam can be modulated by a digital signal processor (DSP).

FIG. 1E illustrates a functional block diagram of PBF system 100 in accordance with an aspect of the present disclosure. It should be noted that FIG. 1E shows some components that are not shown in FIGS. 1A-D for the sake of clarity.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with and/or be communicatively coupled with a PBF system 100, and/or other AM systems, via one or more wired and/or wireless interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may store and provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

Processor 152 may comprise or be a component of a processing system implemented with one or more processors. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117a and/or 117b remaining in depositor 101, location of depositor 101, location of nozzles for hopper 115a and/or 115b, location of pixels and/or voxels, leveler 119 position, and other signals. DSP 158 may be used in processing signals received by the computer 150. The DSP 158 may be configured to generate instructions and/or packets of instructions for transmission to PBF system 100.

The user interface 160 may comprise a speaker, microphone, camera, sensor(s), keypad or keyboard, a pointing device, and/or a display that can be touchscreen in some aspects. The user interface 160 may include any element or component or combinations thereof that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described herein with respect to the processor 152, but also to implement the functionality described herein with respect to the signal detector 156, the DSP 158, and/or the user interface 160. Further, each of the components illustrated in FIG. 1E may be implemented using a plurality of separate elements.

Also shown in FIG. 1E may include one or more sensor(s) 199. Sensor(s) 199 can include one or more sensors in some aspects. In various aspects, sensor(s) 199 can be configured as part of PBF system 100, as shown in FIG. 1E, or may be included in a separate component coupled to PBF system 100. In some aspects sensor(s) 199 can be located partially or wholly within chamber 113 and may be physically and/or communicatively coupled with one or more other components of PBF system 100, depending on the functionality of a particular sensor and its use in the PBF system 100. Sensor(s) 199 can include one or more of optical sensors, temperature sensors, movement sensors, audio sensors, chemical sensors, pressure sensors, weight sensors, distance sensors, proximity sensors, orientation sensors, velocity sensors, speed sensors, acceleration sensors, electromagnetic sensors, radiation sensors, humidity/moisture sensors, and/or others, as appropriate and/or required. Sensor(s) 199 can include one or more communications interface, as appropriate and/or required.

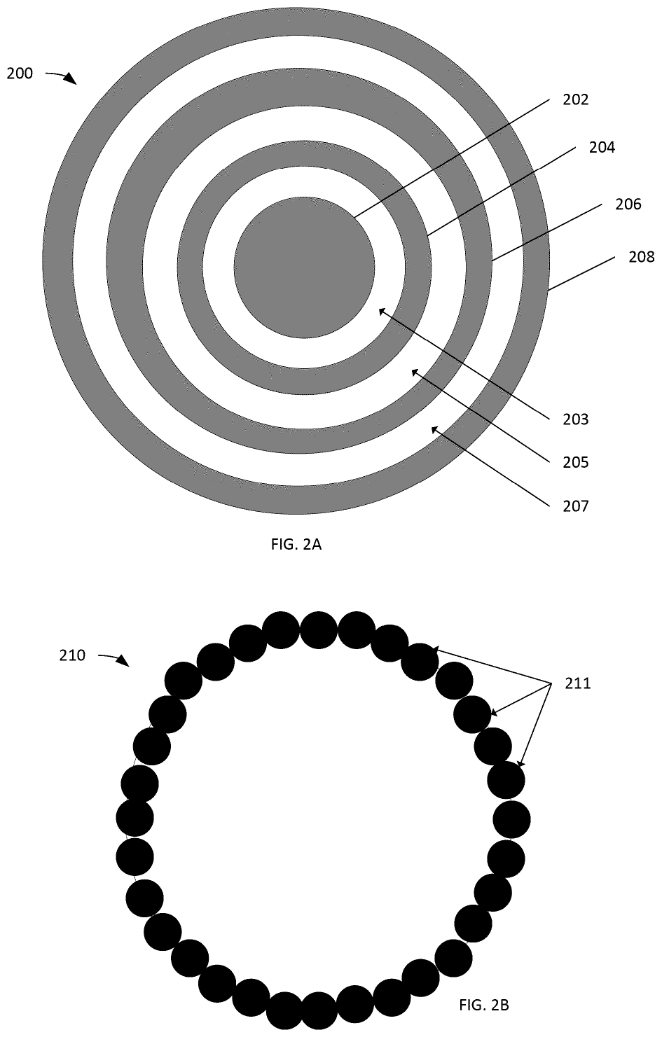

FIG. 2A illustrates a cross-sectional view of a multi-mode ring fiber optic configuration 200 in accordance with aspects of the present disclosure.

As shown, a core 202 can be surrounded by a first ring 204, which can be surrounded by a second ring 206, which can be surrounded by a third ring 208. Core 202 and rings 204, 206, 208 can share a common center axis. Core 202 can be separated from first ring 204 by cladding 203. First ring 204 can be separated from second ring 206 by cladding 205. Second ring 206 can be separated from third ring 208 by cladding 207. Additional rings and claddings are contemplated but are omitted from the present disclosure to maintain simplicity and clarity. Although multi modular ring mode fiber optic configuration 200 is shown with a core (i.e., core 202) that creates a spot (e.g., Gaussian) beam, in various embodiments a multi modular ring mode fiber optic configuration may not include a core. In other words, various embodiments may include only ring beams, i.e., without a core that creates a spot beam.

Alternatively or additionally, one or more of the first ring 204, the second ring 206, the third ring 208, and/or additional ring(s) can be generated via multiple narrow single mode fibers 211, as shown in FIG. 2B.

FIG. 2B illustrates a cross-sectional view showing how one or more rings of a multi-mode ring fiber optic configuration 210 may be generated in accordance with aspects of the present disclosure. As shown, a plurality of narrow single mode fibers 211 can be used to decorate or otherwise comprise one or more rings of a multi-mode ring configuration, e.g., one or more of the rings shown in FIG. 2A may comprise a plurality of single mode fibers. In some aspects, each narrow single mode fiber 211 has an equivalent diameter, while in other aspects, the diameters may differ between rings or within a ring, between single mode fibers 211. In a ring with multiple diameter single mode fibers 211, the single mode fibers 211 may be regularly (i.e., uniformly) or irregularly distributed, and diameters of different sizes may alternate in a regular pattern or irregularly, in various aspects. These single mode fibers 211 can be used to make large features with no compromise between optical productivity and feature size. Furthermore, in aspects where single mode fibers 211 are used, they can make features small compared to the size of rings, build pieces, or other metrics.

In some additive manufacturing printers, including those using laser powder ped fusion (LPBF), it can be desirable in certain aspects to selectively adjust an energy beam (e.g., a laser) spot or ring size (e.g., magnification) and/or power distribution. This can be useful during a scanning process of a single layer, between layers, and others. Magnification may be achieved through optical means (i.e., “zooming”) using a single beam. Ring mode lasers can also be used for beam shaping purposes. Combining magnification and utilizing ring modes can broaden a process window, but may increase the complexity and therefore the difficulty of optic calibration and control. Delivering a fixed spot size “as-fiber” can enable decoration of the fiber cross-section with a relatively small core of a laser and then distributing additional power through one or more of a first ring, a second ring, a third ring, and/or additional rings. An example core diameter is ten to fifteen micrometers. Employing such a configuration can provide for the creation and use of small features and a core fiber can be fired on by a laser with a single mode and Gaussian distribution. This can result in each ring having a different light, as provided by a different ring power. Each ring can also perform as a different spot size. If all rings are powered on together, a large, broad beam can be generated with a holistically uniform power distribution. This is particularly the case where multiple single-mode fibers are used in one or more of the rings. Different power combinations can be modularly distributed across rings and provide for different patterns to be applied by a user or system employing the laser.

For the following examples, abbreviations are used to provide simplicity and clarity: a maximum power is “P”, a first ring is “R1”, a second ring is “R2”, a third ring is “R3”. Note that in various embodiments, the Core can be a spot beam or a ring beam.

Example 1: Core=R1=R2=R3=P. This example embodiment may generate a large, broad power beam with a distribution that mimics a large top hat mode.

Example 2: Core=R1=R2=P, R3=0. This example embodiment may generate a slightly smaller broad power than in Example 1 that mimics a medium top hat mode.

Example 3: Core=P, R1=0, R2=0, R3=P/2. This example embodiment may generate a large ring for pre-heat/post-heat passes of the laser with the core generally in charge of melting functionality. This can also be referred to as keyhole mode.

Core=0, R1=P/2, R2−0, R3=P. This example embodiment may generate a large spot for applications where a coaxial benefit from ring mode is desirable internally for material properties improvement during additive manufacturing.

Core=0, R1=P, R2=P, R3=0. This example embodiment may generate a thick ring.

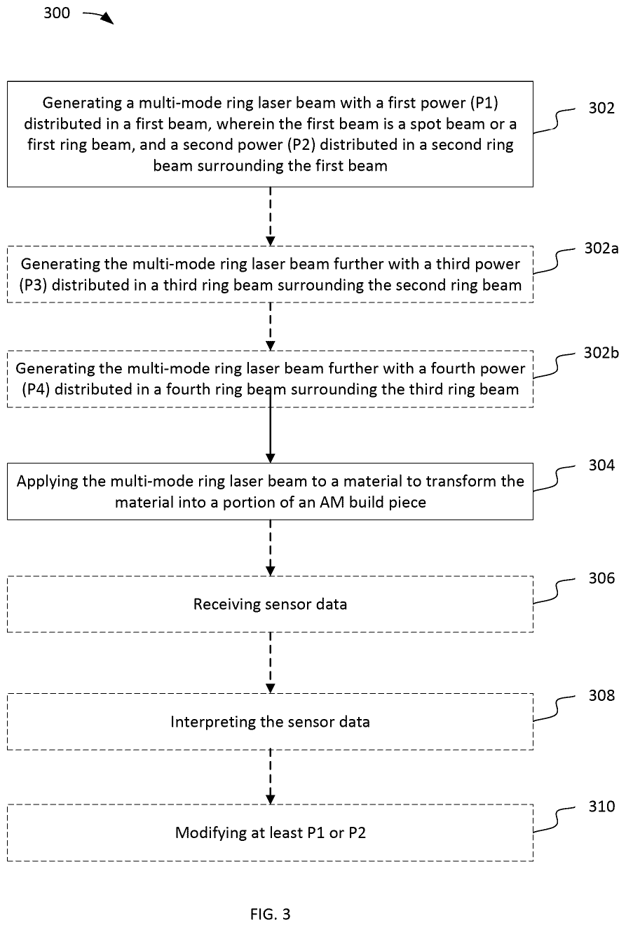

FIG. 3 illustrates a flowchart 300 of a method of additive manufacturing with a multi modular ring mode fiber optic configuration in accordance with various aspects of the present disclosure.

In some aspects, the techniques described herein relate to a method of additive manufacturing (AM) with a multi-mode ring laser beam (e.g., energy beam 127), including generating (302) a multi-mode ring laser beam with a first power (P1) distributed in a first beam, wherein the first beam is a spot beam (e.g., spot beam 202) or a first ring beam (e.g., first ring beam 204), and a second power (P2) distributed in a second ring beam (e.g., second ring beam 206) surrounding the first beam. In some aspects, the techniques described herein relate to a method, further including optionally generating (302a) the multi-mode ring laser beam further with a third power (P3) distributed in a third ring beam (e.g., third ring beam 208) surrounding the second ring beam (e.g., second ring beam 206). In some aspects, the techniques described herein relate to a method, further including optionally generating (302b) the multi-mode ring laser beam further with a fourth power (P4) distributed in a fourth ring beam surrounding the third ring beam (e.g., third ring beam 208).

The example method further includes applying (304) the multi-mode ring laser beam to a material (e.g., powder 117) to transform the material into a portion of an AM build piece (e.g., build piece 109).

In some aspects, the techniques described herein relate to a method, wherein the spot beam is generated to include a Gaussian power distribution.

In some aspects, the techniques described herein relate to a method, wherein the second ring beam is generated to include a plurality of individual laser beams.

In some aspects, the techniques described herein relate to a method, wherein the plurality of individual laser beams are generated via single mode fiber lasers.

In some aspects, the techniques described herein relate to a method, wherein the second ring beam is located concentrically around the first beam.

In some aspects, the techniques described herein relate to a method, wherein each of P1, P2, P3, and P4 are equivalent.

In some aspects, the techniques described herein relate to a method, wherein each of P1, P2, and P3 are equivalent, and wherein P4 is zero.

In some aspects, the techniques described herein relate to a method, wherein each of P2 and P3 are zero, and wherein P4 is half of P1.

In some aspects, the techniques described herein relate to a method, wherein each of P1 and P3 are zero, and wherein P2 is half of P4.

In some aspects, the techniques described herein relate to a method, wherein each of P1 and P4 are zero, and wherein P2 is equivalent to P3.

In some aspects, the techniques described herein relate to a method, further including optionally receiving (306) sensor data (e.g., from sensor(s) 199), interpreting (308) the sensor data, and modifying (310) (e.g., via beam power module 179) at least the first beam or the second ring beam based on the interpreted sensor data.

In some aspects, the techniques described herein relate to a method, wherein modifying at least the first beam or the second ring beam includes changing at least an amount of magnification (e.g., via optics module 189) or a power.

In some aspects, the techniques described herein relate to a method, further including modifying (e.g., via optics module 189) an amount of magnification of at least the first beam (e.g., first ring beam 204) or the second ring beam (e.g., second ring beam 206).

In some aspects, the techniques described herein relate to a method, wherein at least the first beam (e.g., first ring beam 204) or the second ring beam (e.g., second ring beam 206) are generated by different lasers.

Considering non-traditional beam energy profiles for AM such as multi-mode distributions (e.g., combined Gaussian and ring mode profiles) can show the value of the various aspects in this document. Here, a further level for fine control can be added by asserting control of energy delivery and distribution from the laser module and proportion that is carried by an inner beam, such as a core beam of the optical fiber (referred to as the “spot” herein) or an inner ring beam, versus the outer ring layers of the fiber simultaneously (e.g., as described above). In various embodiments, the spot can be a Gaussian power profile laser beam. Some systems may enable use of fixed ratios of power. For example, some systems provide for 90% of power in the ring or 10% in the “spot” and allow for varying these percentages in fixed increments from about 100% in the spot with zero in the ring(s), to 50/50 between the spot and the rings, to 90/10 in the spot and rings, respectively. It is a similar problem statement for the simpler scenario described earlier in that the coupled laser and optical scanner, which can generally be galvanometrically steered, which has a tolerance stacked process output from the various diodes, lenses, etc. that is being calibrated within a relatively broad acceptance range on the order of 10-20%, based on modern processing limitations for these components. As described above for dynamic control via fine manipulation of the zoom optic-to-optic, the equivalent system inputs can be modified such as the laser power to the different laser “modes” to make the sources behave far more similarly/equivalently than the current state of industry. In this example aspect, it is possible to slightly modify an energy distribution to 89.8/11.2 or 48.7/51.3 as needed so that the system outputs meet the desired nominal output and dynamic control characteristics. Although example embodiments described above and herein describe a spot laser beam as the inner beam, it should be understood that the inner beam can instead be a ring laser beam in various embodiments.

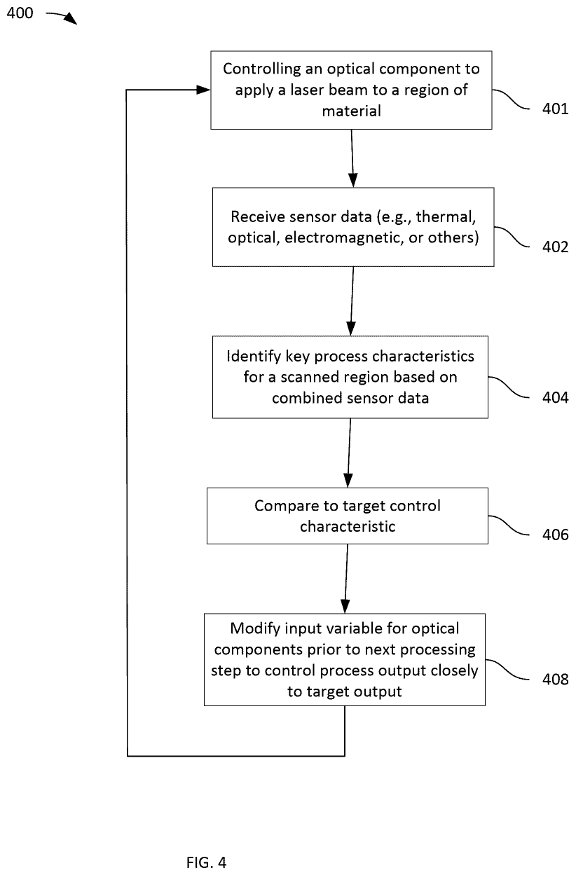

FIG. 4 illustrates a flowchart 400 of a method for fine process control strategy for printer optics in accordance with various aspects of the present disclosure.

In some aspects, the techniques described herein relate to a method for additive manufacturing (AM), including controlling (401) an optical component to apply a laser beam to a region of material during an AM process, receiving (402) sensor data regarding the region, determining or identifying (404) one or more process characteristics of the region based on the sensor data, obtaining (406) a comparison by comparing the process characteristic(s) to a target characteristic(s), and modifying (408) a variable corresponding to control of the optical component based on the comparison, wherein modifying the variable modifies a printing output in accordance with a target output. The processing may be layer to layer and/or vector to vector.

In some aspects, sensors can include photodiodes, optical tomography (OT) cameras, eddy current sensors, and others. It is contemplated that tight and true closed loop process control as described herein can provide improved safety for critical applications, including for printing structures for manned flight applications. These processes may allow for greatly improved control of AM processes without the typical processing time penalties seen in the past. For processing of more complex functionally integrated parts with highly variable geometry from thick-to-thin in close proximity, standard processing parameters may not give consistent material output. On the other hand, the methodology herein may enable a level of process control that can assure similar energy density input and more similar resulting microstructure across a diverse range of geometric features.

In some aspects, the techniques described herein relate to a method, wherein modifying the variable includes modifying the variable after printing a current layer and prior to printing a next layer.

In some aspects, the techniques described herein relate to a method, wherein modifying the variable includes modifying the variable after printing in a first vector and prior to printing in a next vector.

In some aspects, the techniques described herein relate to a method, wherein the sensor data includes data corresponding to one or more of a photodiode, an optical tomography (OT) camera, and an eddy current sensor.

In some aspects, the techniques described herein relate to a method, wherein the target characteristic includes an inferred spot size.

In some aspects, the techniques described herein relate to a method, wherein the process characteristic includes a beam size.

In some aspects, the techniques described herein relate to a method, wherein the target characteristic is a target beam size and obtaining a comparison includes comparing the beam size with the target beam size and determining if the difference between the beam size and the target beam size is within a desired tolerance level.

In some aspects, the techniques described herein relate to a method, wherein the process characteristic includes a beam shape.

In some aspects, the techniques described herein relate to a method, wherein the target characteristic is a target beam shape and obtaining a comparison includes comparing the beam shape with the target beam shape and determining if the difference between the beam shape and the target beam shape is within a desired tolerance level.

In some aspects, the techniques described herein relate to a method, wherein the variable includes laser power. In some aspects, the techniques described herein relate to a method, wherein the laser beam includes a multi-mode ring laser beam, and the variable includes a mode of the multi-mode ring laser. In some aspects, the techniques described herein relate to a method, wherein the mode of the multi-mode ring laser includes a power ratio of the multi-mode ring.

In some aspects, the techniques described herein relate to a system for additive manufacturing, including: one or more optical components; one or more sensors; one or more processors; and one or more memories storing instructions that, when executed by the one or more processors, cause the one or more processors, alone or in combination, to: identify one or more key process characteristics for a scanned region based on sensor data; compare the identified one or more key process characteristics to one or more target control characteristics; and modify one or more input variables for one or more of the plurality of optical components prior to performing a subsequent printing, wherein modifying one or more input variables controls a printing output in accordance with a target output.

In some aspects, the techniques described herein relate to a system, wherein the subsequent printing includes printing a next layer.

In some aspects, the techniques described herein relate to a system, wherein the subsequent printing includes printing in a next vector.

In some aspects, the techniques described herein relate to a system, wherein the one or more sensors further include one or more of photodiode, OT camera, and eddy current sensor data.

In some aspects, the techniques described herein relate to a system, wherein the one or more target characteristics includes an inferred spot size.

In some aspects, the techniques described herein relate to a system, wherein the one or more key process characteristics includes a beam size.

In some aspects, the techniques described herein relate to a system, wherein the beam size is within a desired tolerance level.

In some aspects, the techniques described herein relate to a system, wherein the one or more key process characteristics includes a beam shape.

In some aspects, the techniques described herein relate to a system, wherein beam shape is within a desired tolerance level.

In some aspects, the techniques described herein relate to a system, wherein the one or more input variables includes laser power.

In some aspects, the techniques described herein relate to a method of additive manufacturing, including: depositing a powder first material in a powder bed; exposing the powder first material to a second material; and applying a laser beam with a wavelength to the powder first material and the second material to generate a composite material, wherein an absorption coefficient of the second material is higher than an absorption coefficient of the second material at the wavelength.

In some aspects, the techniques described herein relate to a method, wherein the beam wavelength is less than 600 nanometers (nm).

In some aspects, the techniques described herein relate to a method, wherein the beam wavelength is less than 550 nanometers (nm).

In some aspects, the techniques described herein relate to a method, wherein the beam wavelength is less than 500 nanometers (nm).

In some aspects, the techniques described herein relate to a method, wherein the composite material is an alloy.

In some aspects, the techniques described herein relate to a method, wherein the powder first material is aluminum (Al).

In some aspects, the techniques described herein relate to a method, wherein the second material has a higher thermal conductivity than the powder first material.

In some aspects, the techniques described herein relate to a method, wherein the second material includes copper, gold, nickel, or iron.

In some aspects, the techniques described herein relate to a method, wherein an absorptivity percentage of the powder first material is less than half of an absorptivity percentage of the second material at the beam wavelength.

In some aspects, the techniques described herein relate to a method, wherein power of the laser is less than 500 kilowatts (kW).

In some aspects, the techniques described herein relate to a method, wherein exposing the powder first material to a second material includes coating the powder first material with the second material.

In some aspects, the techniques described herein relate to a method, wherein exposing the powder first material to a second material includes coating individual grains of the powder first material with the second material.

In some aspects, the techniques described herein relate to a method, wherein the composite material further includes: an amount of the first material; and an amount of the second material, wherein the amount of the second material is less than one order of magnitude of the amount of the first material.

In some aspects, the techniques described herein relate to a method, wherein the composite material further includes: an amount of the first material; and an amount of the second material, wherein the amount of the second material is less two or more orders of magnitude less than the amount of the first material.

In some aspects, the techniques described herein relate to a method, wherein the composite material is generated in situ, during a printing operation of a component.

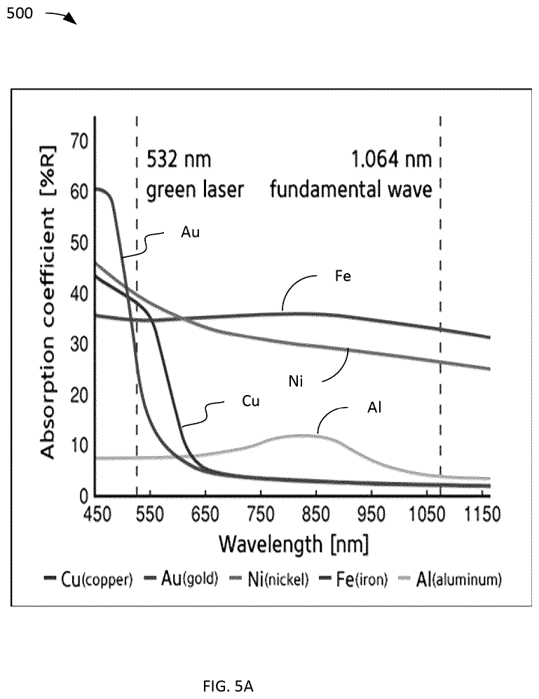

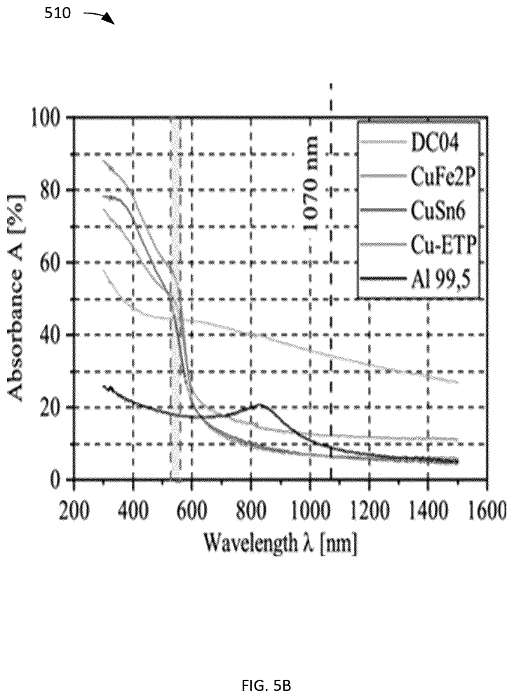

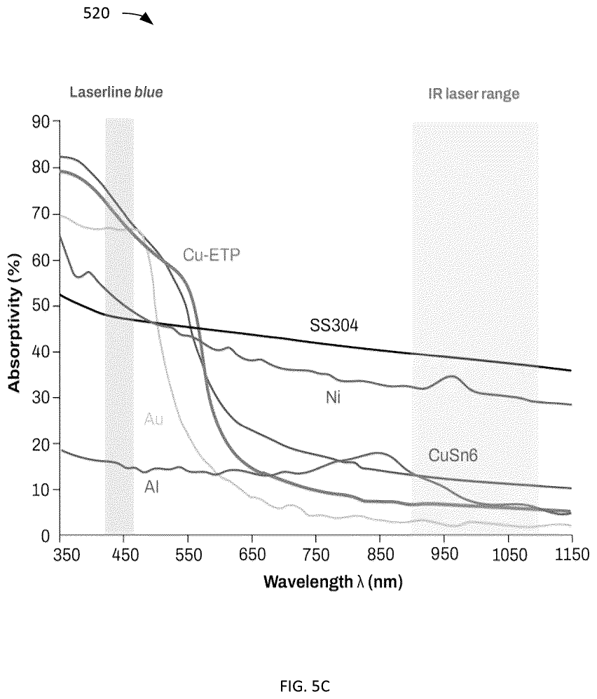

FIG. 5A shows an illustration graph 500 of a laser absorption coefficient for different materials versus wavelength. Graph 500 also shows dotted lines representing application of a green laser at 532 nm wavelength and a near infrared (NIR) laser at a fundamental wavelength of 1,064 nm. As shown in graph 500, the absorption coefficient of aluminum is low (around 10% or less) across the spectrum, including at the green laser's wavelength and the NIR laser's wavelength. However, other materials, such as copper and gold, have a higher absorption coefficient (approximately 35-40%) at the green laser's wavelength, before dropping to around 5% at the NIR laser's wavelength. In other words, copper and gold absorb green laser energy by a factor of around 3-4 times than aluminum. Various embodiments disclosed herein can take advantage of the higher absorption coefficient of various elements (e.g., copper, gold, etc.) at the green laser's wavelength to more efficiently process (e.g., melt) AM materials with a lower absorption coefficient, such as aluminum. For example, aluminum powder may be coated with a nanometric layer of highly absorptive materials at a level of effectiveness for green or blue lasers, such as copper. For example, coating aluminum powder with copper and using a green laser to melt the powder can increase the efficiency of melting because the laser light strikes the outer coating first and deposits most of its energy into the outer copper layer, and the absorption of copper as compared to aluminum is a factor of about 3x. In other words, coating a powder of a low absorption material with a layer of material with a higher absorption can increase the processing (e.g., melting) efficiency of AM processes.

Various embodiments may not require coating powder. For example, instead of or in addition to coating, the higher-absorption material may simply be mixed in with the lower-absorption material. For example, copper powder may be mixed in with aluminum powder deposited in a powder bed of a laser PBF printer.

FIG. 5B shows an illustration graph 510 of a laser absorption coefficient versus wavelength for other example materials, including application of a green laser and a fundamental wave. As shown in graph 510, CuFe2P, CuSn6, Cu-ETP, or even DC04 may be used as the high-absorption material for Al according to various aspects of this disclosure.

FIG. 5C shows an illustration graph 520 of a laser absorption coefficient versus wavelength for other example materials, including application of a blue laser and an infrared laser range, for various materials. As shown in graph 520, Cu-ETP, SS304, Ni, CuSn6, or Au may be used as the high-absorption material for Al according to various aspects of this disclosure.

In various aspects, coating methods such as atomic layer deposition can be implemented to achieve the desired results. Thereafter, once AM build powder is exposed in a chamber with laser, The outer layer fuses and is in situ alloyed with the based substrate particles after full or partial melting. In various aspects, this may be great potential for high copper content alloys, such as the AA2XXX series.

In various embodiments, the second material may include copper, gold, nickel, and/or iron.

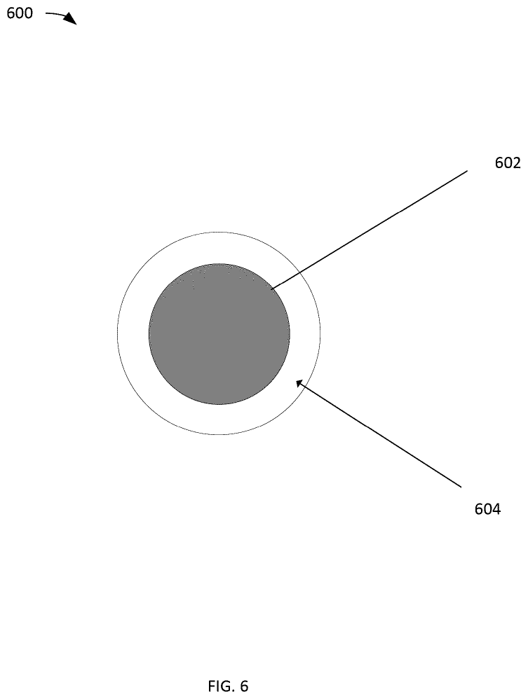

FIG. 6 shows an illustration 600 of a material, including a base material 602 and outer layer 604. In various embodiments base material 602 can be a lower-absorption material, such as aluminum, and outer layer 604 can be a higher-absorption material, such as copper.

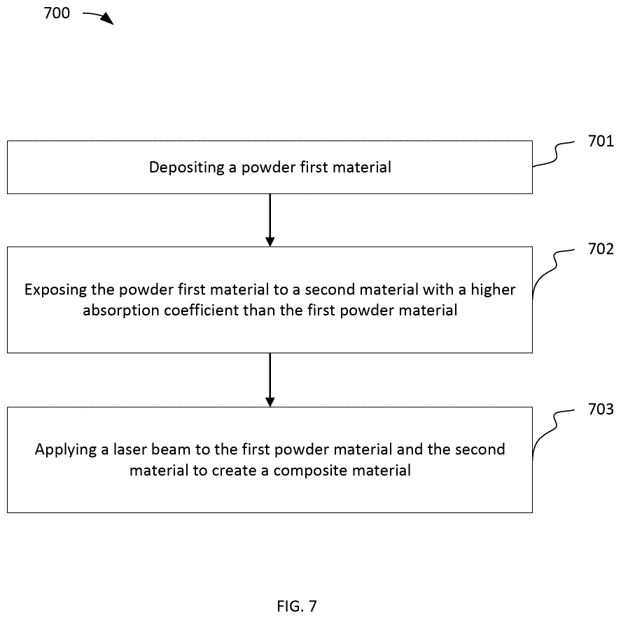

FIG. 7 illustrates an example method according to various embodiments. The method can include depositing (701) a powder first material in a powder bed. In various embodiments, the powder first material can be powdered aluminum. The method further includes exposing (702) the powder first material to a second material, where an absorption coefficient of the second material is higher than an absorption coefficient of the first material at a desired wavelength. For example, the absorption coefficient of the powder first material may be less than half of the absorption coefficient of the second material at the beam wavelength. In various embodiments, exposing the powder first material to the second material can include coating the aluminum powder with a layer of copper. In this regard, it should be appreciated that exposing (702) can occur prior to depositing (701), e.g., the aluminum powder can be coated (i.e., exposed) with the copper prior to the coated powder being deposited (701) in the powder bed. Exposing (702) can include coating individual grains of the powder first material with the second material. For example, atomic layer deposition can be used to coat individual grains of the powder first material. In various embodiments, the amount of the second material may be small compared to the amount of the first material, e.g., less than one order of magnitude of the amount of the first material, less than two orders of magnitude of the amount of the first material, etc.

In various embodiments, the powder first material can be deposited (701) prior to being exposed (702) to the second material, e.g., the aluminum powder may be deposited first, then a layer of copper (e.g., copper powder, copper spray, etc.) may be deposited on top of the aluminum powder. In various embodiments, the powder first material can be deposited (701) at the same time as being exposed (702) to the second material, e.g., the aluminum powder and the copper powder may be deposited at the same time into the powder bed.

The method can further include applying (703) a laser beam with the desired wavelength to the powder first material and the second material to generate a composite material. In various embodiments, the composite material can be an alloy, such as an alloy of aluminum and copper, or e.g., one of the other combinations discussed above. The composite material may be generated in situ, during the printing operation of the component. In various embodiments, the laser beam may be a green laser beam. In various embodiments, the laser beam may be a blue laser beam. In various embodiments, the beam wavelength may be less than 600 nm, less than 550 nm, less than 500 nm, etc. In various embodiments, the power of the laser can be less than 500 kilowatts.

In various embodiments, the second material can have a higher thermal conductivity than the powder first material. For example, copper can have a higher thermal conductivity than aluminum. This may, for example, aid in the transfer of heat energy from the copper coating to the aluminum powder core, which may further serve to increase the efficiency of the AM process.

Using such a method may, for example, reduce the power consumption required in the AM process by factor of three. This may, for example enable process parameters for 1500 W to apply to AM printing of aluminum at 500 W, thus reducing the overall power consumption of an AM process.

This process can be used to print refractory alloys or metal matrix composites (MMCs) with a high percentage of ceramic particles (e.g., 40 to 99%). This can result in the creation of a ceramic particle coated with copper or gold and can use laser powder bed fusion to create geometry by infusing the out layers of particles together.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure. Elements shown in dashed lines in the figures should be considered optional.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In yet another variation, aspects of the present disclosure may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computer system 400. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire. Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 4, above). Accordingly, each module may be realized in a variety of suitable configurations and should not be limited to any particular implementation exemplified herein.

What is claimed is:

1. A method of additive manufacturing (AM) with a multi-mode ring laser beam, comprising:
generating a multi-mode ring laser beam with a first power (P1) distributed in a first beam, wherein the first beam is a spot beam or a first ring beam, and a second power (P2) distributed in a second ring beam surrounding the first beam; and
applying the multi-mode ring laser beam to a material to transform the material into a portion of an AM build piece.

2. The method of claim 1, wherein the spot beam is generated to comprise a Gaussian power distribution.

3. The method of claim 1, wherein the second ring beam is generated to comprise a plurality of individual laser beams.

4. The method of claim 3, wherein the plurality of individual laser beams are generated via single mode fiber lasers.

5. The method of claim 1, wherein the second ring beam is located concentrically around the first beam.

6. The method of claim 1, further comprising generating the multi-mode ring laser beam further with a third power (P3) distributed in a third ring beam surrounding the second ring beam.

7. The method of claim 6, further comprising generating the multi-mode ring laser beam further with a fourth power (P4) distributed in a fourth ring beam surrounding the third ring beam.

8. The method of claim 7, wherein each of P1, P2, P3, and P4 are equivalent.

9. The method of claim 7, wherein each of P1, P2, and P3 are equivalent, and wherein P4 is zero.

10. The method of claim 7, wherein each of P2 and P3 are zero, and wherein P4 is half of P1.

11. The method of claim 7, wherein each of P1 and P3 are zero, and wherein P2 is half of P4.

12. The method of claim 7, wherein each of P1 and P4 are zero, and wherein P2 is equivalent to P3.

13. The method of claim 1, further comprising:
receiving sensor data;
interpreting the sensor data; and
modifying at least the first beam or the second ring beam based on the interpreted sensor data.

14. The method of claim 13, wherein modifying at least first beam or the second ring beam includes changing at least an amount of magnification or a power.

15. The method of claim 1, further comprising modifying an amount of magnification of at least the first beam or the second ring beam.

16. The method of claim 1, wherein at least the first beam or the second ring beam are generated by different lasers.

17. An additive manufacturing (AM) system comprising:
a multi-mode ring laser configured to generate a first beam with a first power (P1) distributed in the first beam, wherein the first beam is a spot beam or a first ring beam, and generate a second ring beam with a second power (P2) distributed in the second ring beam, wherein the second ring beam surrounds the first beam; and
a deflector configured to apply the multi-mode ring laser beam to a material to transform the material into a portion of an AM build piece.

18. The system of claim 17, wherein the spot beam is generated to comprise a Gaussian power distribution.

19. The system of claim 17, wherein the second ring beam is generated to comprise a plurality of individual laser beams.

20. The system of claim 19, wherein the plurality of individual laser beams are generated via single mode fiber lasers.

21. The system of claim 17, wherein the second ring beam is located concentrically around the first beam.

22. The system of claim 17, further comprising generating the multi-mode ring laser beam further with a third power (P3) distributed in a third ring beam surrounding the second ring beam.

23. The system of claim 22, further comprising generating the multi-mode ring laser beam further with a fourth power (P4) distributed in a fourth ring beam surrounding the third ring beam.

24. The system of claim 23, wherein each of P1, P2, P3, and P4 are equivalent.

25. The system of claim 23, wherein each of P1, P2, and P3 are equivalent, and wherein P4 is zero.

26. The system of claim 23, wherein each of P2 and P3 are zero, and wherein P4 is half of P1.

27. The system of claim 23, wherein each of P1 and P3 are zero, and wherein P2 is half of P4.

28. The system of claim 23, wherein each of P1 and P4 are zero, and wherein P2 is equivalent to P3.

29. The system of claim 17, further comprising:
receiving sensor data;
interpreting the sensor data; and
modifying at least P1 or P2 based on the interpreted sensor data.

30. The system of claim 29, wherein modifying at least P1 or P2 includes changing an amount of magnification.

31. The system of claim 17, further comprising modifying an amount of magnification of at least the first beam or the second ring beam.

32. The system of claim 17, wherein at least the first beam or the second ring beam are generated by different lasers.

33. A method for additive manufacturing (AM), comprising:
controlling an optical component to apply a laser beam to a region of material during an AM process;
receiving sensor data regarding the region;
determining a process characteristic of the region based on the sensor data;
obtaining a comparison by comparing the process characteristic to a target characteristic; and
modifying a variable corresponding to control of the optical component based on the comparison,
wherein modifying the variable modifies a printing output in accordance with a target output.

34. The method of claim 33, wherein modifying the variable comprises modifying the variable after printing a current layer and prior to printing a next layer.

35. The method of claim 33, wherein modifying the variable comprises modifying the variable after printing in a first vector and prior to printing in a next vector.

36. The method of claim 33, wherein the sensor data comprises data corresponding to one or more of a photodiode, an optical tomography (OT) camera, or an eddy current sensor.

37. The method of claim 33, wherein the target characteristic comprises an inferred spot size.

38. The method of claim 33, wherein the process characteristic comprises a beam size.

39. The method of claim 38, wherein the target characteristic is a target beam size and obtaining a comparison comprises comparing the beam size with the target beam size and determining if the difference between the beam size and the target beam size is within a desired tolerance level.

40. The method of claim 33, wherein the process characteristic comprises a beam shape.

41. The method of claim 33, wherein the target characteristic is a target beam shape and obtaining a comparison comprises comparing the beam shape with the target beam shape and determining if the difference between the beam shape and the target beam shape is within a desired tolerance level.

42. The method of claim 33, wherein the variable comprises laser power.

43. The method of claim 33, wherein the laser beam comprises a multi-mode ring laser beam, and the variable comprises a mode of the multi-mode ring laser.

44. The method of claim 43, wherein the mode of the multi-mode ring laser comprises a power ratio of the multi-mode ring.

45. A system for additive manufacturing, comprising:
one or more optical components;
one or more sensors;
one or more processors; and
one or more memories storing instructions that, when executed by the one or more processors, cause the one or more processors, alone or in combination, to:
identify one or more key process characteristics for a scanned region based on sensor data;
compare the identified one or more key process characteristics to one or more target control characteristics; and
modify one or more input variables corresponding to control of one or more of the plurality of optical components prior to performing a subsequent printing,
wherein modifying one or more input variables modifies a printing output in accordance with a target output.

46. The system of claim 45, wherein the subsequent printing comprises printing a next layer.

47. The system of claim 45, wherein the subsequent printing comprises printing in a next vector.

48. The system of claim 45, wherein the one or more sensors further comprise one or more of a photodiode, an optical tomography (OT) camera, and an eddy current sensor.

49. The system of claim 45, wherein the one or more target characteristics comprises an inferred spot size.

50. The system of claim 45, wherein the one or more key process characteristics comprises a beam size.

51. The system of claim 50, wherein the target characteristic is a target beam size and obtaining a comparison comprises comparing the beam size with the target beam size and determining if the difference between the beam size and the target beam size is within a desired tolerance level.

52. The system of claim 45, wherein the one or more key process characteristics comprises a beam shape.

53. The system of claim 45, wherein the target characteristic is a target beam shape and obtaining a comparison comprises comparing the beam shape with the target beam shape and determining if the difference between the beam shape and the target beam shape is within a desired tolerance level.

54. The system of claim 45, wherein the one or more input variables comprises laser power.

55. A method of additive manufacturing, comprising:
depositing a powder first material in a powder bed;
exposing the powder first material to a second material, wherein an absorption coefficient of the second material is higher than an absorption coefficient of the first material at the wavelength; and
applying a laser beam with a wavelength to the powder first material and the second material to generate a composite material.

56. The method of claim 55, wherein the beam wavelength is less than 600 nanometers (nm).

57. The method of claim 55, wherein the beam wavelength is less than 550 nanometers (nm).

58. The method of claim 55, wherein the beam wavelength is less than 500 nanometers (nm).

59. The method of claim 55, wherein the composite material is an alloy.

60. The method of claim 55, wherein the powder first material is aluminum (Al).

61. The method of claim 55, wherein the second material has a higher thermal conductivity than the powder first material.

62. The method of claim 61, wherein the second material comprises copper, gold, nickel, or iron.

63. The method of claim 55, wherein the absorption coefficient of the powder first material is less than half of the absorption coefficient of the second material at the beam wavelength.

64. The method of claim 55, wherein power of the laser is less than 500 kilowatts (kW).

65. The method of claim 55, wherein exposing the powder first material to a second material comprises coating the powder first material with the second material.

66. The method of claim 65, wherein exposing the powder first material to a second material comprises coating individual grains of the powder first material with the second material

67. The method of claim 65, wherein the composite material further comprises:
an amount of the first material; and
an amount of the second material,
wherein the amount of the second material is less than one order of magnitude of the amount of the first material.

68. The method of claim 65, wherein the composite material further comprises:
an amount of the first material; and
an amount of the second material,
wherein the amount of the second material is less two or more orders of magnitude less than the amount of the first material.

69. The method of claim 55, wherein the composite material is generated in situ, during a printing operation of a component.
